(19) United States
(12) Patent Application Publication
(10) Pub. No.: US 2021/0396674 A1
(43) Pub. Date: Dec. 23, 2021

(54) A METHOD FOR DETERMINING CONCENTRATION OF PHOSPHATE

(71) Applicant: Kemira Oyj, Helsinki (FI)

(72) Inventors: Salla PUUPPONEN, Espoo (FI); Sari KRAPU, Espoo (FI)

(21) Appl. No.: 17/281,857

(22) PCT Filed: Sep. 27, 2019
(86) PCT No.: PCT/FI2019/050691

§ 371 Date: Mar. 31, 2021

(30) Foreign Application Priority Data
Oct. 1, 2018 (FI) 20185819

(51) Int. Cl. G01N 21/64; G01N 21/77; G01N 1/34

(52) U.S. Cl. CPC G01N 21/6408; G01N 1/34; G01N 21/77

(57) ABSTRACT

The present invention relates to a method for determining concentration of phosphate in a sample method comprises mixing the sample with a lanthanide (III) chelate or with lanthanide (III) ion and a chelation agent; allowing the phosphate in the sample to interact with the lanthanide (III) chelate; or with the lanthanide (III) ion and the chelation agent; exciting the sample and detecting a sample signal deriving from the sample by using time-resolved luminescence measurement; and determining the concentration of the phosphate in the sample.

### FIELD OF THE INVENTION

The present invention relates to a method for determining concentration of phosphate in a sample with time-resolved fluorescence.

### BACKGROUND

Phosphorous removal and recovery from municipal and industrial wastewater treatment plants is a key factor in preventing eutrophication of surface waters.

Phosphorous is one of the major nutrients contributing in the increased eutrophication of natural waters. High concentrations of phosphorous causes loss of livestock, increase of algae and algal toxic and increase the purification costs. Phosphorous removal and recovery from municipal and industrial wastewater treatment plants is thus a key factor in preventing eutrophication of surface waters.

Phosphate may also cause problematic scaling problems in waste streams, such as struvite formation. The measurement of phosphate species in water is important in order to control the phosphate level of the waters and in order to prevent possible scaling problems in-time.

Several methods for determining phosphate concentration in water have been developed. Examples of such methods are ion chromatography, potentiometric, colorimetric and spectrometric methods.

However, the methods for determining phosphate content in a sample are typically expensive and the analysis is slow and laborious.

There is still need for simple and effective methods for determining phosphate concentration in a sample.

### SUMMARY OF THE INVENTION

On object of the present invention is to provide a method for determining phosphate concentration in a sample comprising phosphate.

Another object of the present invention is to provide a simple and effective method for determining phosphate concentration in a sample comprising phosphate.

The present invention provides a rapid and simple phosphate quantification method based on time resolved fluorescence (TRF) of lanthanide chelates.

The use of TRF removes typical short-lived, interfering fluorescence signal possibly present in the sample medium by temporal resolution (the fluorescence signal is not recorded immediately but after a waiting period or lag time). Lanthanide ions do not only have exceptionally long fluorescence lifetime, but they also have narrow banded emission lines and long Stokes' shift.

Alone, lanthanide ions have very low energy absorption. The absorptivity of the lanthanides is substantially increased by chelating the trivalent lanthanide ion with energy mediating ligands. In aqueous solutions, the ligands increase the absorptivity and protect the lanthanide ion from water molecules that quench the fluorescence signal by radiationless decay process of lanthanide and OH groups of water.

The inventors surprisingly found that phosphate ions quench the TRF signal of lanthanide chelates due to the strong interactions of trivalent phosphate anion and trivalent lanthanide cation. The phosphate anions deprive lanthanide cations from the chelate, resulting in decrease in TRF signal. This reduction in the signal intensity can be utilized for phosphate quantification.

In the method of the present invention a sample comprising phosphate is excited at a excitation wavelength, and a sample signal deriving from the lanthanide (III) ion at a signal wavelength is detected by using TRF, and the concentration of the phosphate in the sample is determined by using the detected sample signal.

The detected TRF signal is compared to a calibration curve for determining the concentration of phosphate. The signal reduction is proportional to the concentration of phosphate present in the sample.

### BRIEF DESCRIPTION OF THE FIGURES

FIG. 1 illustrates TRF signal of maleic acid—sodium allyl sulfonate (SASMAC) chelated europium as a function of added phosphate.

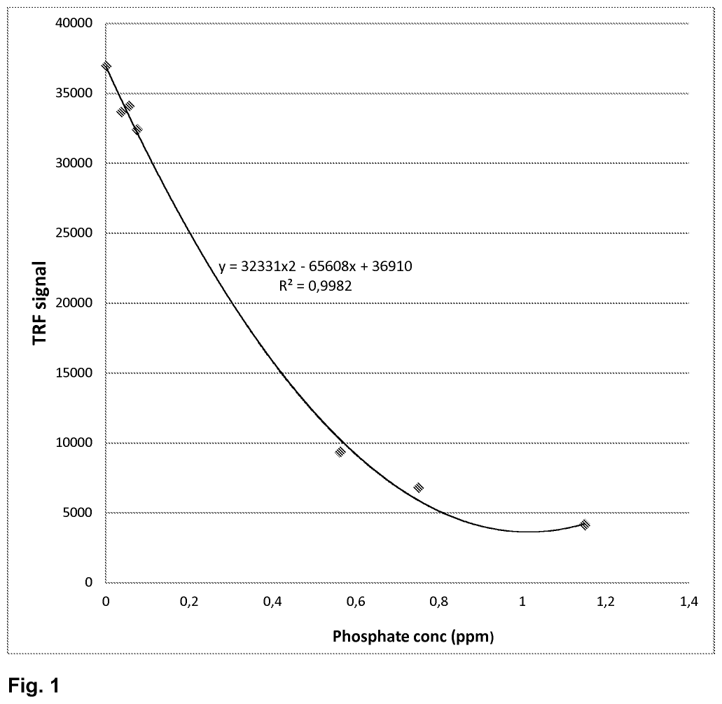

### DETAILED DESCRIPTION

The present invention provides a method for determining concentration of phosphate in a sample. More particularly the present invention provides a method for determining concentration of phosphate in a sample comprising phosphate, the method comprising
optionally diluting and/or purifying the sample;
admixing the sample with a reagent comprising a lanthanide (III) chelate or chelates and allowing the phosphate in the sample to interact with the reagent comprising the lanthanide (III) chelate or chelates; or
admixing the sample with a reagent comprising lanthanide (III) ion and admixing a chelation agent to the mixture comprising the sample and the lanthanide (III) ion and allowing the phosphate in the sample to interact with the reagent comprising the lanthanide (III) ion and the chelation agent or chelation agents;
exciting the sample at a excitation wavelength and detecting a sample signal deriving from the sample at a signal wavelength by using time resolved fluorescence measurement; and
determining the concentration of the phosphate in the sample by using the detected sample signal.

In one embodiment the sample is admixed with the reagent comprising a lanthanide (III) chelate or chelates and the phosphate in the sample is allowed to interact with the reagent comprising the lanthanide (III) chelate or chelates.

In another embodiment the sample is first admixed with a reagent comprising Ianthanide(III) ion followed by admixing a chelation agent or chelation agents to the mixture comprising the sample and the lanthanide (III) ion and allowing the phosphate in the sample to interact with the reagent comprising the lanthanide (III) ion and the chelation agent or chelation agents.

With the method of the present invention phosphate concentrations in wide ranges can be determined. In one embodiment phosphate concentration in measurement mixture is in the range of 0.001-1000 ppm, preferably 0.01-100 ppm, and more preferably 0.1-10 ppm.

In case the concentration of the phosphate in the sample is higher, the sample can be diluted.

In one embodiment concentration of the lanthanide (III) ion in the measurement mixture is in the range 0.1-100 μM, preferably 0.1-50 μM, and more preferably 1-20 μM.

In other embodiment concentration of the chelating agent in the measurement mixture is in the range of 0.001-1000 ppm, preferably 0.01-100 ppm.

By term “measurement mixture” is meant the admixture in the measurement.

The lanthanide (III) ion is selected from europium, terbium, samarium or dysprosium ions, preferably europium or terbium ions.

In a preferred embodiment the lanthanide (III) ion is a lanthanide (III) salt. The lanthanide (III) salt is selected from halogenides and oxyanions, such as nitrates, sulfates or carbonates, preferably from hydrated halogenides or nitrates, more preferably chloride.

The chelating agent comprises at least one or more functional groups capable of chelating lanthanide (III) ions. Preferably the one or more groups are selected from esters, ethers, thiols, hydroxyls, carboxylates, sulfonates, amides such as peptides, phosphates, phosphonates, amines or any combinations thereof.

In an embodiment, chelating agent contains additionally aromatic group or groups. The aromatic group(s) amplifies the signal of the lanthanide (III) ion.

If the sample contains interfering compounds such as trivalent metal cations or chelating agents that may affect TRF signal, it can be purified.

The sample is optionally diluted to suitable aqueous solution e.g. deionized water or brine containing monovalent and/or divalent ions. Preferably, the dissolution brine does not contain any trivalent ions. Preferably the sample is an aqueous solution.

If the sample solution contains some interfering compounds such as trivalent metal cations or chelating agents that may affect TRF signal, suitable purification procedures may be applied prior to the dilution steps.

The sample is optionally purified by using a purification method selected from centrifugation, size exclusion chromatography, cleaning with solid-phase extraction (SPE) cartridges, dialysis techniques, extraction methods for removing hydrocarbons, filtration, microfiltration, ultrafiltration, nanofiltration, membrane centrifugation, pH adjustment, reductive/oxidative pretreatment, removal of interfering compounds by chelation/complexation or precipitation, and any combinations thereof.

In one embodiment pH value of the sample is adjusted to a level in range between pH 2 and pH 8, preferably in range from pH 5 to pH 7.5.

In a preferred embodiment buffer is used in the measurement for standardization of the pH. The buffering agent is selected from a group consisting of Good's zwitterionic buffering agents, bis-trispropane, piperazine-N,N′-bis(2-ethanesulfonic acid) (PIPES), cholamine chloride, 2-morpholinopropanesulfonic acid (MOPS), 2-hydroyxy-3-morpholin-4-ylpropane-1-sulfonic acid (MOPSO), 4-(2-hydroxyethyl)-1-piperazineethanesulfonic acid (HEPES), glycinamide, glycylglycine, bicine and 3-(cyclohexylamino)-1-propanesulfonic acid (CAPS), preferably HEPES. The pH should not be excessively alkaline in order to prevent possible precipitation of the lanthanide hydroxides.

Unknown concentration of the phosphate in the sample is determined by comparing the sample signal to calibration curve. The calibration curve is obtained from TRF measurement of calibration standard samples with varying phosphate concentrations. Same dilution and or purification steps and measurement parameters have to be used for both the sample and calibration samples.

The lanthanide (III) ion is excited at excitation wavelength and measured at emission wavelength and detected by using time-resolved fluorescence (TRF). Any TRF reader can be employed. Excitation and emission wavelengths are selected so that the S/N is the best. Also the delay time can be optimized.

The excitation and emission wavelengths and the delay time are chosen based on the requirements of the lanthanide ion.

In an exemplary embodiment excitation wavelength and emission wavelength and delay time for Europium is 395 nm and 615 nm and 400 μs respectively.

The present invention further relates to use of the method of the present invention for determining concentration of phosphate in a sample.

The sample can originate from municipal and industrial wastewater treatment processes or natural waters.

The present invention further relates a device comprising means for performing the method according to the present invention for determining concentration of phosphate in a sample.

The examples are not intended to limit the scope of the invention but to present embodiments of the present invention.

### EXAMPLES

### Example 1

The lanthanide and sample were diluted in MQ water, and the chelating agent and buffer were diluted in brine. The brine composition used is presented in Table 1. EuCl₃.6H₂O was used as lanthanide source, and sodium allyl sulphonate maleic acid (SASMAC) polymer as chelating agent. Sodium phosphate was used as exemplary phosphate source in the tests. 0.75 ml of sample solution (phosphate amount varied between 0 and 3 ppm) is mixed with 0.75 ml of 0.208 mM lanthanide (aq), after which 0.5 ml of brine solution containing 5 mM HEPES buffer (pH adjusted to 7.4) and 80 ppm of SASMAC chelating agent are added to the lanthanide—phosphate solution. The TRF signal of the mixtures was measured after lag time of 400 μs. The excitation and emission wavelengths used were 295 nm and 615 nm, respectively. The ion/reagent concentrations in the measurement solution are presented in Table 2.

The same procedure can be used with different reagent concentrations and other concentrations. The chelating agent can be replaced by other suitable chelating agents. In the case of samples containing high concentration of phosphate, the samples are diluted to suitable concentration range prior to the measurement. Suitable purification steps can be also applied for process water samples.

TABLE 1
Brine composition used in tests. Salts are weighed
in a bottle and diluted in 10 kg of MQ water.

| Salt | Mass (g) |
|---|---|
| NaCl | 350.3 |
| CaCl₂*2H₂O | 22.4 |
| MgCl2*6H₂O | 14.6 |
| KCl | 2.1 |
| BaCl₂*2H₂O | 1.3 |

TABLE 2
Ion concentrations in the phosphate TRF measurements.
The SASMAC polymer and HEPES concentrations are
20 ppm and 2 mM in all the measurements.

| Ion | Concentration in the measurement (mM) |
|---|---|
| PO₄³⁻ | 0-0.014 |
| Eu³⁺ | 0.078 |
| Na⁺ | ~150 |
| Ca²⁺ | 3.8 |
| Mg²⁺ | 1.8 |
| K⁺ | 0.7 |
| Ba²⁺ | 0.1 |
| Cl⁻ | 162.1 |

1. A method for determining concentration of phosphate in a sample comprising phosphate, the method comprising:
optionally diluting and/or purifying the sample;
admixing the sample with a reagent comprising a lanthanide (III) chelate or chelates and allowing the phosphate in the sample to interact with the reagent comprising the lanthanide (III) chelate or chelates; or
admixing the sample with a reagent comprising lanthanide (III) ion and admixing a chelation agent or chelation agents to the mixture comprising the sample and the lanthanide (III) ion and allowing the phosphate in the sample to interact with the reagent comprising the lanthanide (III) ion and the chelation agent;
exciting the sample at a excitation wavelength and detecting a sample signal deriving from the sample at a signal wavelength by using time resolved fluorescence measurement; and
determining the concentration of the phosphate in the sample by using the detected sample signal.

2. The method according to claim 1, wherein concentration of the phosphate in the measurement mixture is in the range of 0.001-1000 ppm, preferably 0.01-100 ppm, and more preferably 0.1-10 ppm.

3. The method according to claim 1, wherein concentration of the lanthanide (III) ion in the measurement mixture is in the range 0.1-100 μM, preferably 0.1-50 μM, and more preferably 1-20 μM.

4. The method according to claim 1, wherein concentration of the chelating agent in the measurement mixture is in the range of 0.001-1000 ppm, preferably 0.01-100 ppm.

5. The method according to claim 1, wherein the lanthanide (III) ion is selected from europium, terbium, samarium or dysprosium ions, preferably europium or terbium ions.

6. The method according to claim 1, wherein the lanthanide (III) ion is a lanthanide (III) salt, preferably halogenide or oxyanion, more preferably hydrated halogenides or nitrates, most preferably chloride.

7. The method according to claim 1, wherein the chelating agent comprises at least one or more functional groups capable of chelating lanthanide (III) ions, preferably one or more groups selected from esters, ethers, thiols, hydroxyls, carboxylates, sulfonates, amides, phosphates, phosphonates, amines or any combination thereof.

8. The method according to claim 1, wherein the chelating agent chelating agents contain additionally aromatic group or groups.

9. The method according to claim 1, wherein the sample is purified by using a purification method selected from the group consisting of centrifugation, size exclusion chromatography, cleaning with solid-phase extraction (SPE) cartridges, dialysis techniques, extraction methods for removing hydrocarbons, filtration, microfiltration, ultrafiltration, nanofiltration, membrane centrifugation, pH adjustment, reductive/oxidative pretreatment, removal of interfering compounds by chelation/complexation or precipitation, and any combinations thereof.

10. The method according to claim 1, wherein additionally a buffer solution comprising a buffering agent is admixed with the sample.

11. The method according to claim 9, wherein the buffering agent is selected from the group consisting of Good's zwitterionic buffering agents, bis-trispropane, piperazine-N,N′-bis(2-ethanesulfonic acid) (PIPES), cholamine chloride, 2-morpholinopropanesulfonic acid (MOPS), 2-hydroyxy-3-morpholin-4-ylpropane-1-sulfonic acid (MOPSO), 4-(2-hydroxyethyl)-1-piperazineethanesulfonic acid (HEPES), glycinamide, glycylglycine, bicine, and 3-(cyclohexylamino)-1-propanesulfonic acid (CAPS).

12. Method according to claim 1, wherein a pH value of the sample is adjusted to a level in range between pH 2 and pH 8, preferably in range from pH 5 to pH 7.5.

13. Use of the method according to claim 1 for determining concentration of phosphate in a sample.

14. The use according to claim 13, wherein the sample originates from municipal and industrial wastewater treatment processes or natural waters.

15. A device comprising means for performing the method according to claim 1 for determining concentration of phosphate in a sample.
